(19) United States
(12) Patent Application Publication
(10) Pub. No.: US 2006/0093101 A1
(43) Pub. Date: May 4, 2006

(54) Method and system for interactive voice response in a communications sytem

(75) Inventors: Premal V. Patel, Plano, TX (US); Jon A. Ratcliff, The Colony, TX (US); Jeffrey D. Copley, Garland, TX (US)

Correspondence Address: HAYNES AND BOONE, LLP, 901 MAIN STREET, SUITE 3100, DALLAS, TX, 75202, US

(73) Assignee: Wirenix, Inc., Dallas, TX (US)

(21) Appl. No.: 11/252,837

(22) Filed: Oct. 18, 2005

Related U.S. Application Data
(60) Provisional application No. 60/619,626, filed on Oct. 18, 2004.

(51) Int. Cl. H04M 11/00; H04M 7/00

(52) U.S. Cl. 379/88.16; 379/220.01

(57) ABSTRACT

A method, system, and computer-readable medium for providing a full feature redundant interactive voice response system in a telecommunications system is provided. The interactive voice response system comprises an extendable system that provides fixed or variable part announcement playback to a calling party. A message is received from a service control point. The message includes an announcement identifier. A determination that an announcement including at least one variable part is to be played is made. Contents of the message are translated into a value for retrieving at least one variable part audio file from a data storage, and the at least one variable part audio file is retrieved. The interactive voice response system may also provide playback of announcements of multiple languages.

### RELATED APPLICATION DATA

This patent application claims the benefit of provisional U.S. patent application Ser. No. 60/619,626, filed Oct. 18, 2004.

### FIELD OF THE INVENTION

The present invention relates generally to communication systems and, more particularly, to a method and system for providing interactive voice response capabilities in a communications system.

### BACKGROUND OF THE INVENTION

The use of communication systems through which to communicate data is an endemic part of modern society. For example, telephonic communication systems have been widely employed and are regularly utilized by a large number of users. Telephonic networks of various telephonic communication systems have been installed throughout significant portions of the populated areas of the world. Telephonic stations are connected to the telephonic network, such as by a wireline connection or a radio interface. A communication session is formed between two or more of the telephonic stations connected to the telephonic network. The telephonic station at which a call is originated may be referred to as the calling party, and the telephonic station at which the call is to be completed, or terminated, may be referred to as the called party.

In most conventional telephonic communication systems, circuit-switched connections are provided between endpoints, i.e., the calling and called parties, during a communication session. When a circuit-switched connection is formed, a dedicated channel is provided to permit the telephonic communications between the telephonic stations that form the endpoints of the communication sessions.

An important part of the communication system is the capability to automate interactive responses with the user community. Interactive responses may be provided via direct communication with a customer service center or electronically via an interactive voice response system (IVR).

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating an embodiment of a communication system operable to provide interactive voice response or other interactivity;

FIG. 2 is a diagrammatic representation of an embodiment of an interactive voice response system configured in an SS7 network;

FIG. 3 is a diagrammatic representation of an embodiment of a database configured for storing fixed phrases in an announcement store;

FIG. 4 is a diagrammatic representation of an embodiment of a database comprising a table that may maintain variable part phrases that may be retrieved by an interactive voice response system;

FIG. 5 is a diagrammatic representation of an announcement message that may be sent from a service control point to an interactive voice response system for directing the interactive voice response system to play an announcement;

FIG. 6 is a diagrammatic representation of an embodiment of a minimal interactive voice response system configuration;

FIG. 7 is a diagrammatic representation of an interactive voice response system in a non-extended and fully loaded configuration;

FIG. 8 is a diagrammatic representation of an embodiment of a first incremental expansion of an interactive voice response system;

FIG. 9 is a diagrammatic representation of another embodiment of an expanded interactive voice response system configuration;

FIG. 10 is a flowchart of an embodiment of an IVR message processing routine for providing IVR redundancy; and

FIG. 11 is a diagrammatic representation of an embodiment of an IVR configuration for communicating using multiple languages.

### DETAILED DESCRIPTION

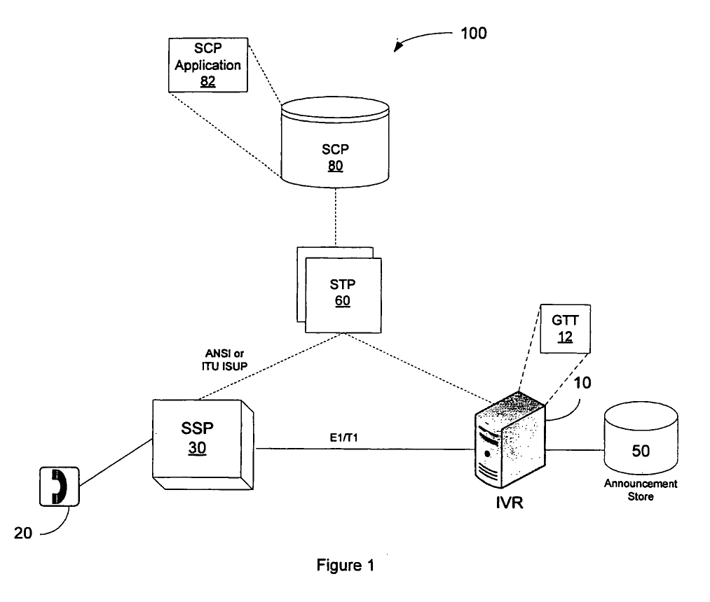

FIG. 1 is a block diagram illustrating an embodiment of a communication system 100 operable to provide interactive voice response or other (such as DTMF) interactivity. The communication system may comprise a telephonic or other suitable communication system that is operable to provide communications between communication, computational, or other devices.

The communication system comprises a switch 30, such as a mobile switching point (MSC), a service switching point (SSP) or another device adapted to channel or direct data received at one or more input ports to one or more output ports, a Service Control Point (SCP) 80, an Interactive Voice Response System (IVR) 10, and optionally a signaling transfer point (STP) 60. IVR 10 has signaling connections to STP 60 or it may have direct signaling connections with SCP 80 or SSP 30. STP 60 has signaling connections with SCP 80 and SSP 30. Additionally, T1, E1, or other trunking connections may be deployed between IVR 10 and one or more SSPs. A user terminal device 20 interfaces with SSP 30 via a communication medium, such as a copper twisted pair, fiber optic link, a wireless link, or another suitable communication medium. Additionally, there may be more than one SCP deployed in system 100 connected using the connections described above.

IVR 10 provides announcements or other information to a user and collects user information. To this end, IVR 10 interfaces with, or is otherwise communicatively coupled with, an announcement store 50. Decisions may be made based on information collected from a user, that is voice, DTMF, or other input supplied by a user to device 20. To provide service, a customer places a phone call via device 20 that is intercepted by SSP 30. SSP 30 sends an SS7 query message to SCP 80 to request instructions. For illustrative purposes, assume an SCP application 82 recognizes an IVR service is needed to properly process the call. SCP 80 passes addressing information via SS7 back to SSP 30 which directs SSP 30 to connect to IVR 10. SCP 80 may include in the information passed to SSP 30 addressing and transaction information to be used by IVR 10 for purposes of routing and transaction identification with the SCP. The addressing information may comprise, for example, an eleven digit E.164 address previously assigned to the SCP and a five digit correlation identifier. SSP 30 makes both a trunk connection and a signaling connection to IVR 10 using ISUP signaling, e.g., by using an SS7 call control Initial Address Message (IAM). SSP 30 populates the called party number field of the IAM message with the E.164 address and correlation identifier received from the SCP (i.e., the SCP addressing and transaction information), and then sends the message to IVR 10. IVR 10 uses the addressing information to establish communication with SCP 30 regarding the call. To this end, IVR 10 translates the E.164 address into a point code and subsystem number. The derived point code can be the point code of the SCP or the point code of the STP. This translation enables the ability for the prepaid system to support more than one SCP. The translation is accomplished via the use of a global title translation (GTT) table 12. Table 12 comprises user provisioned E.164 addresses with at least one point code and subsystem number assigned to each E.164 address. When an LAM message is received, the IVR retrieves the E.164 address. It then accesses the GTT table, finds the E.164 entry that matches the E.164 address received in the IAM message, and retrieves the point code and subsystem number. These values are used to form the message destined for the SCP. The E.164 address and subsystem number are stored in the message per SS7 protocol formatting in the Signaling Connection Control Part (SCCP) of the message. The point code is stored in the Message Transfer Point (MTP) destination point code field.

A second part of the SCP communication setup is to populate the Transaction Capabilities Application Part (TCAP) of the message being built. The correlation identifier received in the IAM message is stored in an application part of the TCAP portion of the message. The application part is formatted as an Assist-Request-Instructions message formatted according to the Customized Applications for Mobile network Enhanced Logic (CAMEL) protocol. The IVR also establishes a dialogue identifier in the TCAP message to correlate messages between the SCP and the IVR. Once formatted, the IVR sends the message into the network. SS7 routing is used by the network to deliver the message based on the populated values. Upon receipt of the message, the SCP uses the correlation ID to associate the message with the subscriber's call. SCP 80, using SS7 addressing information received and the dialogue ID, begins communication via SS7 with IVR 10 directing IVR 10 what announcements to play, what information to collect, how to collect it, and when the call is complete. This is accomplished through the use of CAMEL protocol messages including Play Announcement, Prompt and Collect. Upon completion, the call is disconnected. Completion is initiated upon request from the SCP or a release message from the switch.

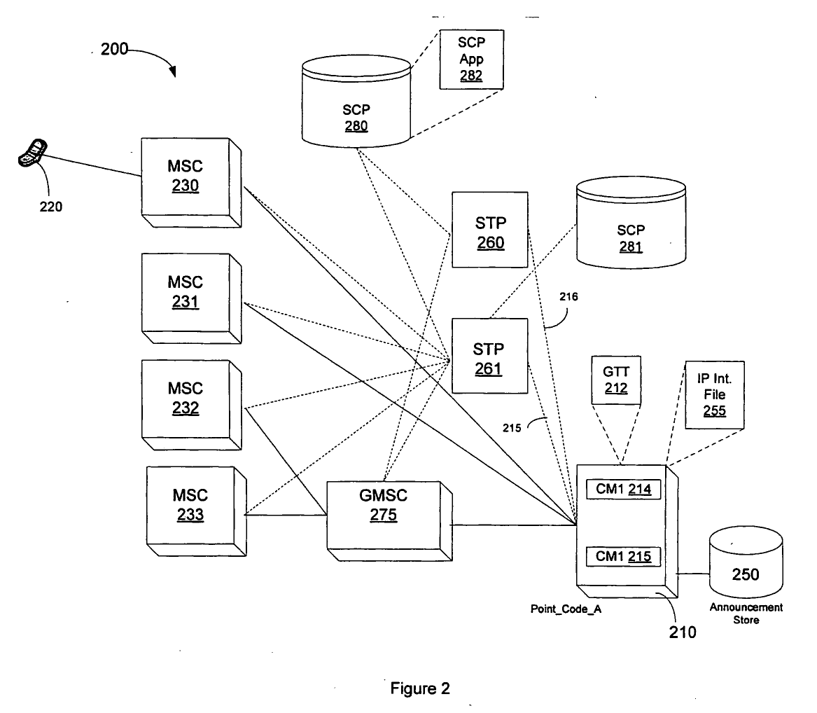

FIG. 2 is a diagrammatic representation of an embodiment of an IVR configured in an SS7 network. IVR 210 connects to the signaling network via SS7 links 215 and 216 with STPs 260 and 261. SS7 interconnections (illustratively designated with dashed lines) may also be made directly to the end nodes. In an embodiment, at least four SS7 links may be interconnected to IVR 210 with at least two links directed to a first control manager (CM) 214 and at least two links directed to a second control manager 215. The IVR may interface with a gateway mobile switching center (GMSC) 275 interconnected with mobile network infrastructure, e.g., MSCs 232 and 233. GMSC 275 may terminate public switched telephone network (PSTN) signaling and traffic and convert PSTN signaling and traffic to formats suitable for use by a mobile network. IVR 210 is assigned a single point code (illustratively denoted Point_Code_A) even if IVR 210 is implemented as a cluster of nodes or operational units. Though the SS7 links run to different CMs, the IVR responds as if it is one node. By this implementation, the SS7 network treats the CMs as just one network element with a single point code assigned thereto. Advantageously, this configuration allows internal redundancy within IVR 210 such that one CM can fail and the other will continue to have active SS7 signaling connections. SS7 links are preferably engineered at 0.4 erlang or less. Such engineering ensures that in the event of signaling link failure, sufficient capacity and resources of IVR 210 remain available to support the failed link's traffic amongst the other links in the link set thereby allowing for one CM to handle all the SS7 traffic if a failure of all SS7 links to the other CM should occur. Preferably, messages are delivered to IVR 210 evenly distributed amongst the links in the link set (i.e., in accordance with SS7 load sharing procedures). FIGS. 1 and 2 are intended as exemplary network systems in which embodiments may be implemented, and not as an architectural limitation of embodiments described herein.

SS7 signaling links are presented to IVR 210 utilizing two T1 or E1 spans. Each T1/E1 span presents a substantially equal distribution of signaling traffic in nominal conditions to separate control managers within IVR 210 for redundancy purposes. Regardless of which CM receives an SS7 message, IVR 210 performs the requested action provided the necessary resources are available. For example, an SS7 message regarding resources on a particular CM or an underlying expansion module (EM) thereof may be received on another CM and vice versa.

Similarly, bearer channels are connected to IVR 210 via T1 or E1 spans. The trunks in the trunk group or groups are preferably evenly distributed between the IVR's bearer facilities (i.e., between each CM and its underlying EMs). IVR 210 is configured so that in the event a CM or EM fails, enough capacity remains in IVR 210 to continue processing all calls, both bearer and signaling. A call in progress will be lost if the CM or EM associated with that call fails. However, new connectivity and existing calls on the other CM will continue. To support bearer redundancy, it is preferable to implement each trunk group at 50% capacity in normal mode (that is, when all CMs are operational). In this scenario, a failure of one CM and its associated EMs results in the other CM (assuming an IVR with two CMs) handling all traffic including the traffic directed to the non-operational CM.

As shown in FIG. 2, IVR 210 interfaces with MSCs 230-233 using SS7 ISUP messages via STP 261 to establish bearer paths from a subscriber device, e.g., communication device 220, on a need basis. IVR 210 also interfaces with one or more Service Control Points 280-281, such as SCP 280, using an SS7 SCCP Global Title Translation (GTT) table 212 for routing and CAMEL protocol for application data to obtain instructions on the services IVR 210 needs to perform for the desired application. IVR 210 is developed as a generic platform and may support any application that will implement the same interface. In other words, the IVR application(s) itself need not be aware of which application is invoking its services.

In accordance with embodiments, IVR 210 supports both fixed and variable announcements. A fixed announcement comprises a pre-recorded announcement and is played as previously recorded. A variable announcement is composed of one or more message segments based on the call context. A variable announcement contains, or is derived from, variables that can take different values on a dynamic basis. Such announcements are very versatile and may be heavily used in different applications. When SCP 280, or an application 282 running thereon, instructs IVR 210 to play an announcement, it sends an announcement ID (AnnId) to IVR 210. The instructions provided by SCP 280 to IVR 210 may also include instruction or directives to play multiple variable parts or segments.

Fixed announcements comprise prerecorded content, e.g., phrases or other audible content, installed on the system and assigned, or otherwise associated with, an announcement ID. Fixed phrases may be maintained in announcement store 250 (or announcement store 50 shown in FIG. 1) that is interfaced with IVR 210. Multiple fixed phrases may be assigned to an announcement ID. Each fixed phrase or segment comprises an audio formatted file, such as a .wav-formatted file. IVR 210 plays all fixed phrases associated with an announcement ID upon a request from the SCP. Any number of fixed phrases may be assigned in the announcement database to each announcement ID.

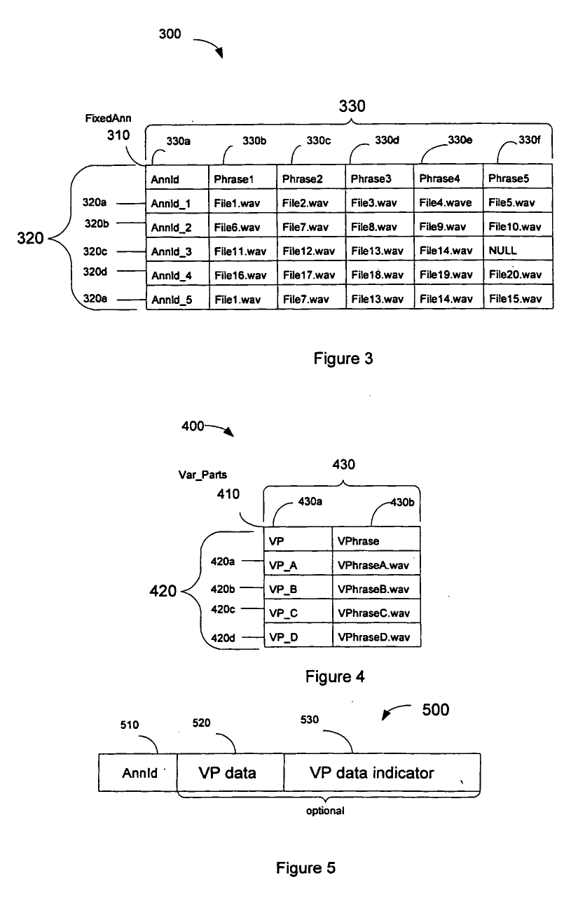

With reference to FIG. 3, there is shown a diagrammatic representation of an embodiment of a database 300 configured for storing fixed phrases in announcement store 250. Database 300 comprises a table 310 comprising a plurality of records 320 and fields 330. Table 310 may be stored on a disk drive or other storage device of announcement store 250, fetched therefrom, and processed by IVR 210 shown in FIG. 2. Each record 320a-320e, or row, comprises data elements in respective fields 330a-330f.

Table 310 has a label, or identifier, assigned thereto. In the present example, table 310 has a label of “FixedAnn.” Fields 330a-330f (collectively referred to as fields 330) have a respective label, or identifier, that facilitates insertion, deletion, querying, or other data operations or manipulations of table 310. In the illustrative example, fields 330a-330f have respective labels of “AnnId”, “Phrase1”, “Phrase2”, “Phrase3”, “Phrase4,” and “Phrase5.” A particular field, e.g., field 330a, may be designated as a key field and each respective data element is unique within key field 330a. In the illustrative figure, data elements comprising AnnIds (illustratively designated AnnId_1-AnnId_5) each respectively comprise a key to a respective record 320a-320e (collectively referred to as records 320). Assignment of unique values to data elements of field 330a provides an identifier for records 320a-320e and the collection of data elements of field 330a is typically referred to as an index. Addressing a particular record 320a-320e via an associated data element of field 330a is referred to as indexing of record 320a-320e. Alternatively, a key may be obtained by a function, e.g., a hashing function, that indexes a particular record 320a-320e.

In the illustrative example, the AnnId key field 330a includes data elements that comprise announcement identifiers for respectively indexing records 320a-320e. Each of fields 330b-330f may include an audio file, such as a .wav-formatted file, that comprises an announcement phrase or segment. For example, record 320a includes phrase files File1.wav-File5.wav stored in respective fields 330b-330f. In a similar manner, each of records 320b-320e may include phrase files in respective fields 330b-330f. One or more of fields 330b-330f may exclude a phrase file, that is a record of table 310 is not required to have a phrase file in each of fields 330a-330f. For example, record 320c includes a phrase file in fields 330b-330e but field 330f of record 320c is nulled and does not include a phrase file. Additionally, phrase files may be included in more than one record. For example, record 320e includes phrase files File1.wav, File7.wave, and files File13.wav-File14.wav that are respectively included in records 320a, 320b and 320c. Although data elements of fields 330b-330f are illustratively shown as comprising audio-formatted files, in other implementation fields 330b-330f may include references to audio files rather than audio files themselves. For example, fields 330b-330f may store pointers to audio-formatted files rather than the .wav formatted files. In this manner, storage space required for maintaining the audio-formatted files may be reduced, particularly in the event that a number of phrase files are repeated in multiple records 320.

In operation, when IVR 210 receives an AnnId from SCP 280, IVR 210 interrogates database 300 with the AnnId. If a match between the AnnId received from SCP 280 is made with a data element in key AnnId field 330a, data elements of the record having the matching key are retrieved by the IVR from fields 330b-330f of the record. The retrieved phrase files may then be sequentially played back to the calling party by the IVR.

Variable announcements comprise one or more phrases or segments associated with an announcement ID that are derived at run-time based on input (referred to herein as variable parts) received by IVR 210 from SCP 280. Variable parts are data used to index into an intelligent peripheral (IP) interpretation file 255 resulting in a desired variable phrase.

A variable part may be used as a key to index a database for retrieval of a variable part phrase stored as an audio file, e.g., a .wav-formatted file. FIG. 4 is a diagrammatic representation of an embodiment of a database 400 comprising a table 410 that may maintain variable part phrases that may be retrieved by IVR 210. Table 410 may be stored in announcement store 250 (or announcement store 50 shown in FIG. 1). Table 410 comprises a plurality of records 420 and fields 430. Each record 420a-420d comprises data elements in field 430b.

In the illustrative example, table 410 has a label of “Var_Parts” assigned thereto. Fields 430a-430b have respective labels of “VP” and “VPhrase.” Field 430a maintains data elements comprising valid variable parts (VPs) and may be designated as the key field of table 410. In the illustrative example, data elements comprising VPs (illustratively designated VP_A-VP_D) each respectively comprise a key to a respective record 420a-420d.

In the illustrative example, VP key field 430a includes data elements that comprise variable part values for respectively indexing records 420a-420d. Field 430b may include audio files, such as .wav-formatted files, that comprise a variable phrase or segment. For example, field 430b includes variable phrase files VPhraseA.wav-VPhraseD.wav stored in respective records 420a-420d. Although data elements of field 430b are illustratively shown as comprising audio-formatted files, in other implementations field 430b may include references to variable part audio files rather than phrase files themselves.

In operation, when SCP 280 determines variable parts are to be played, it sends IVR 210 a list of one or more variable parts along with an announcement ID. The variable parts and announcement ID may be sent in a common message or sent separately by SCP 280. IVR 210 retrieves phrase files associated with the announcement ID, e.g., by selecting a record of table 310 (or another data structure) with the received AnnId, and the list of variable parts received from SCP 280, e.g., by retrieving variable phrases from table 410 that having matching variable parts (in field 430a) with the variable parts received by the IVR. To play the request, IVR 210 plays the first fixed phrase file followed by the first variable part phrase. It continues alternating play between fixed and variable parts until either list is exhausted. When one list is exhausted, the IVR continues to play the remaining files of the non-exhausted list.

FIGS. 3 and 4 are intended as examples of data structures that may comprise or reference audio files for retrieval by an IVR to facilitate generation of announcement messages that may be transmitted or conveyed to a subscriber device for playback thereby, and not as a limitation of embodiments described herein. In one implementation, tables 310 and 410 may be implemented as .vox formatted files.

FIG. 5 is a diagrammatic representation of an announcement message 500 that may be sent from SCP 280 to IVR 210 for directing IVR 210 to play an announcement. Announcement message 500 includes an announcement ID field 510 that includes an AnnId value. Announcement message 500 is processed by the IVR to determine what announcement to play. The announcement may comprise a fixed or variable announcement. The AnnId is read from announcement field 510 and may be used as a pointer or index into announcement table(s) maintained in announcement store 250, such as tables 310 or 410. The tables comprise, but are not limited to, phrase files that are assigned to the AnnId. If announcement message 500 does not include variable parts, the AnnId is used to index into a table of phrase files comprising fixed announcements, and one or more phrase files obtained by the IVR are played in sequential order and may be of any length.

In addition to the AnnId received from the SCP, the SCP may also indicate that a variable part (VP) is to be played. For example, announcement message 500 may include one or more optional VP fields, such as a VP data field 520 and a VP data indicator field 530. The VP data indicator indicates whether the VP data of field 520 should be interpreted as one of a predefined data type. For example, the VP data indicator may indicate whether the data provided should be interpreted as one of the following:

Date (year, month, day)

Time (hours, minutes)

Price (dollars, cents)

Integer

Number (to be read out digit by digit)

Variable part phrases may, for example, comprise pre-recorded phrases or terms such as “hour,” “minutes,” “dollar,” etc., that are inserted into appropriate locations of an audio signal before the final announcement is played to the subscriber. The SCP application may pass time, date, etc., which may be parsed by an announcement application running on IVR 210 to derive the values for which announcements are recorded at the IVR.

The data indicator, in addition to the VP data provided, is used to interpret the data and play the data in a desired form. The VP data, the VP data indicator, or a combination thereof may be used as (or used to derive) an index or key to obtain a variable phrase from a table of variable phrases. For example, the VP data and VP data indicator read from fields 520 and 530 may be used to form a key used to index a record in table 410 and obtain a variable part phrase therefrom. There may be up to a predefined number, such as five, variable parts provided with each AnnId. That is, multiple instances of fields 520 and 530 may be included in announcement message 500 with each VP data and VP data indicator pair defining a respective variable part. The variable parts are played alternatively between each fixed phrase associated with the AnnId. For example, if there are five fixed phrases assigned to an AnnId, the first fixed phrase is played followed by the first variable part. The next fixed phrase is than played followed by the next variable part. This sequence is continued until the list of the fixed phrases assigned to the AnnId is exhausted or the number of variable parts is exhausted. The remaining variable parts are played if the list of fixed announcements is exhausted. Likewise, the remaining fixed phrases are played if the list of variable parts is exhausted.

The IVR also provides special announcement processing. Special announcement processing is the IVR's capability to perform other functions based on receipt of specially assigned announcement IDs. In this implementation, when the IVR receives one of the special announcement IDs, it performs special procedures such as database access and special return codes other than just playback of announcements and collecting information.

The IVR is preferably deployed as a cluster that includes dual control units called Control Modules (CMs) that jointly handle the Signaling System No. 7 (SS7) signaling interfaces but collectively present a single SS7 nodal appearance to the network (i.e., one point code).

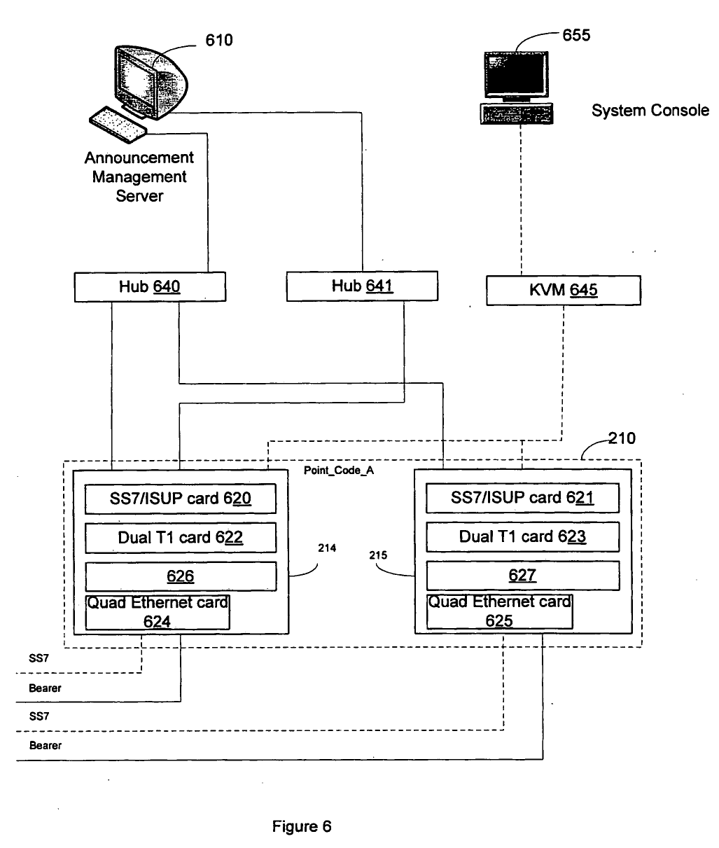

With reference now to FIG. 6, an embodiment of a minimal IVR configuration is shown. Two CMs 214 and 215 of an IVR are communicatively coupled with an announcement management server 610 by way of hubs 640 and 641 or other suitable network infrastructure. A system console 655 may interface with CMs 214 and 215 via a keyboard, video, mouse (KVM) module 645 or another interconnection and provides administrative access to the IVR. KVM 645 allows for switchably interfacing with CMs 214 and 215. In the illustrative example, IVR 210 comprises two CMs 214 and 215. Each CM 214 and 215 includes expansion slots, e.g., disposed on a backplane of CMs 214 and 215, for interfacing with various expansion cards. In a minimal preferred configuration, each of CMs 214 and 215 include an SS7/ISUP card 620 and 621, a dual T1 card 622 and 623, and a quad Ethernet card 624 and 625, respectively. In this configuration, it is preferable that CMs 214 and 215 include at least one respective vacant expansion slot 626 and 627 for extending the capabilities of the IVR as discussed hereinbelow. Dual T1/E1 cards 622-623 respectively provide connectivity to two T1/E1 spans. As discussed above, CMs 214 and 215 are preferably loaded such that failure or unavailability of one of the CMs results in the remaining CM being able to process traffic directed to the failed CM. Notably, each of CMs 214 and 215 share the IVRs single point code (illustratively designated as Point_Code_A).

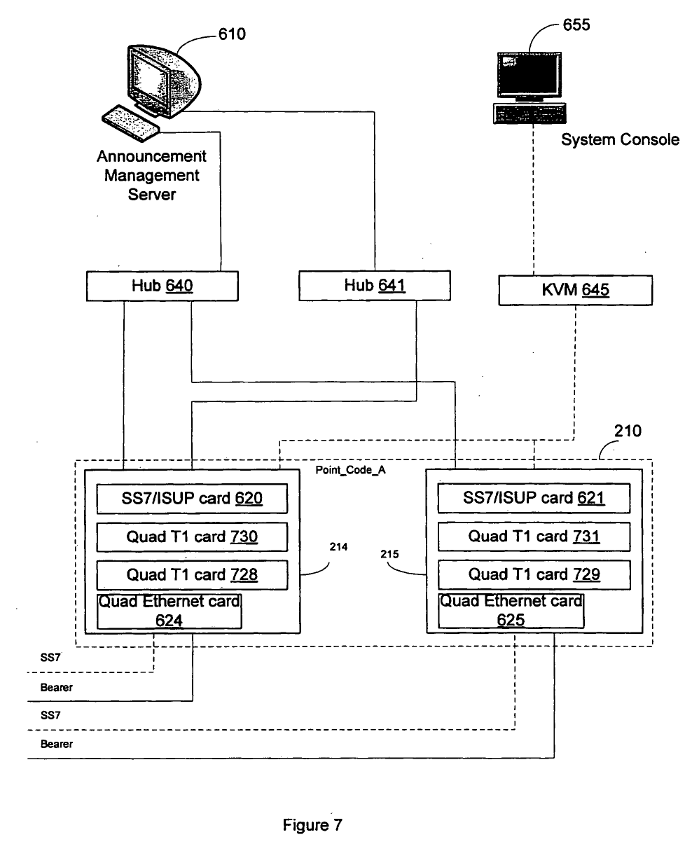

With reference now to FIG. 7, a diagrammatic representation of IVR 210 in a non-extended and fully loaded CM configuration is shown. In this configuration, dual T1 cards 622-623 shown in FIG. 6 have been replaced with Quad T1 cards 730-731, and each expansion slot 626 and 627 shown in FIG. 6 has been loaded with a respective Quad T1 card 728 and 729. Quad T1 cards 728-731 respectively provide four T1/E1 spans. Thus, CMs 214-215 are each configured for a total of eight T1/E1 's spans (192 bearer channels).

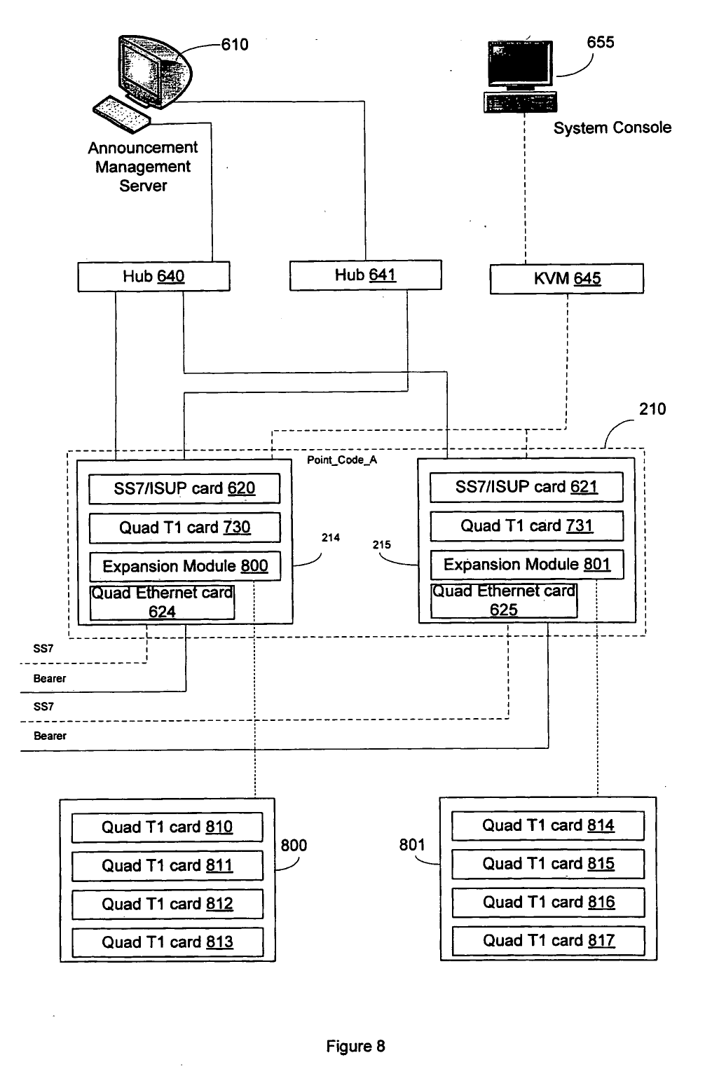

In accordance with an embodiment, the CM capacities of IVR 210 may be extended by loading expansion modules into one or more expansion slots of the CMs. A diagrammatic representation of an embodiment of a first incremental expansion of the IVR beyond the CM maximum configuration shown in FIG. 7 is implemented by loading a pair of expansion modules (EMs) (one EM per CM) as shown in FIG. 8. EMs are deployed in IVR 210 in pairs for reliability purposes. In the illustrative example, CM 214 has an EM 800 inserted into an expansion slot thereof, and CM 215 has an EM 801 inserted into an expansion slot thereof. EMs 800 and 801 include a plurality of expansion slots with which T1/E1 cards may be interfaced thereby expanding the capacity of IVR 210. In the present example, EMs 800-801 respectively have four expansion slots, and thus eight T1/E1 cards 810-817 can be added to the EM pair (i.e., four T1/E1 cards per EM).

EMs 800 and 801 may be implemented as, for example, a respective PCI Extension card deployed in a respective CM 214 and 215. Each PCI Extension card utilizes a CM card slot that may otherwise be utilized for a T1/E1 card (e.g., as shown in FIG. 7) and thus increases overall system connectivity via the additional T1/E1 cards interfaced with the EMs. A pair of CMs and EMs in this configuration provides maximum connectivity to 40 T1s (960 bearers).

The EMs in these configurations are used for bearer housing purposes only. All the SS7 and IVR application intelligence is maintained within each CM. The CM connects to the appropriate channel on an EM when the CM determines an appropriate action such as playback of an announcement or digits collection. All bearers, including those provided by T1/E1 cards inserted in an EM, under the control of a CM will be lost if the CM is removed from service.

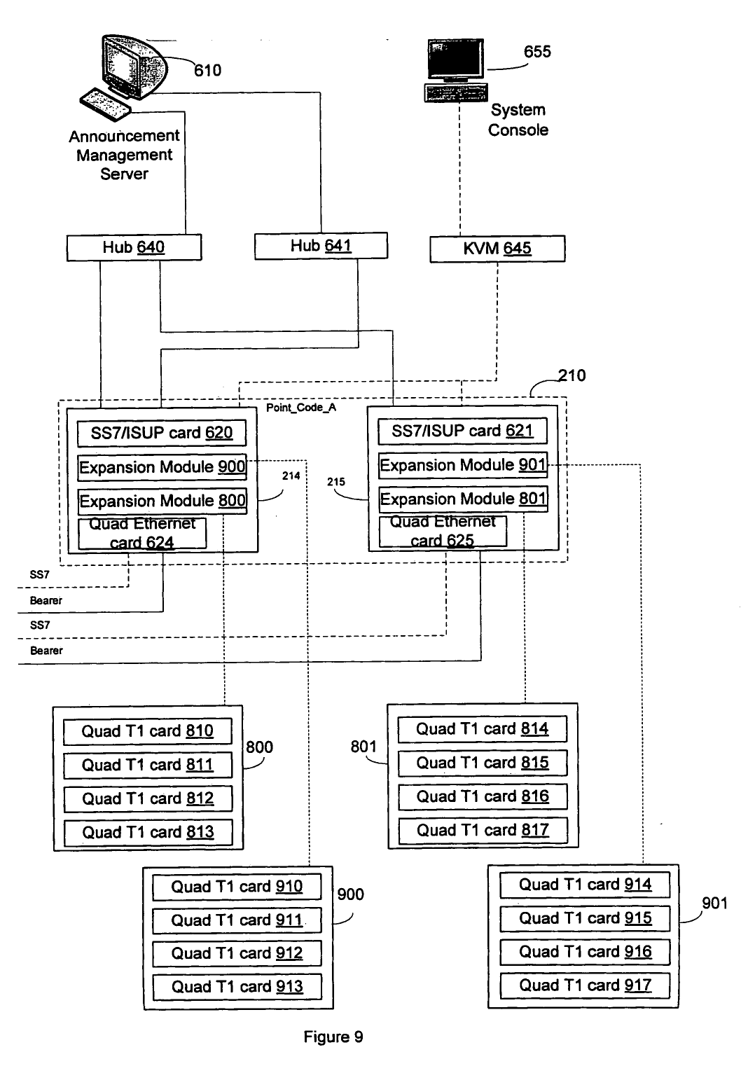

With reference now to FIG. 9, a diagrammatic representation of another embodiment of an expanded IVR configuration is shown. In this implementation, a second pair of EMs 900 and 901 has been added to the IVR CMs. Particularly, EM 900 is inserted into an expansion slot of CM 214, and EM 901 has been inserted into an expansion slot of CM 215. Like the addition of the first pair of EMs, EMs 900 and 901 may be implemented as a PCI Extension card, respectively. With two EMs per CM, CMs 214-215 no longer have T1/E1 cards interfaced with the CM backplane since both available T1/E1 card positions now contain PCI Extension cards. This configuration supports a maximum of sixteen quad T1/E1 cards bringing a fully loaded system (i.e., four EMs) to 64 T1/E1s (1,536 bearer channels in T1 configuration).

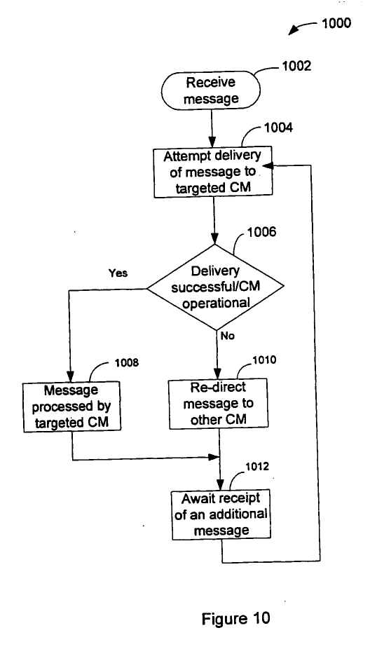

As noted above, the various IVR configurations provide for internal redundancy by implementation of multiple CMs commonly assigned a point code. FIG. 10 is a flowchart of an embodiment of an IVR message processing routine for providing IVR redundancy. The IVR processing routine may be implemented as computer-executable instructions, such as one or more routines, subroutines, methods, or other instruction sets, that may be retrieved from a computer-readable medium and executed by a processing unit, such as a general purpose processing unit of IVR 210 shown in FIG. 2.

The IVR processing routine may be invoked on receipt of a message (step 1002), e.g., on receipt of a signaling message or a message received over a bearer channel. A message received by IVR 210 on a signaling or bearer channel is directed to a particular one of CMs 214 and 215, e.g., by way of logical associations of links with CMs. An attempt is made to deliver the received message to the targeted CM (step 1004). An evaluation may be made to determine if delivery of the message to the targeted CM is successful (step 1006) or if the targeted CM is operational. In the event the message is successfully delivered to the targeted CM, the message is processed thereby (step 1008), and the IVR processing routine may then await receipt of another message for processing (step 1012).

Returning again to step 1006, in the event the message is not successfully delivered to the targeted CM or it is determined that the CM is non-operational or is otherwise unavailable, the IVR processing routine may re-direct or otherwise convey the message to the other CM (step 1010) where it may be processed thereby. The IVR processing routine may then proceed to await receipt of an additional message according to step 1012. When an additional message is received by the IVR, the processing routine may return to step 1004 to attempt delivery of the message to the targeted CM.

In another embodiment, a method for communicating with multiple service control points (SCPs) is provided. In this implementation, the IVR provides three options for communication with service control points. The first two options allow for communicating with just one SCP, e.g., SCP 280 shown in FIG. 2. In one implementation, messages intended for the SCP are routed directly to the SCP using SS7 MTP routing based on point code and subsystem number (SSN). As is known, each network element in an SS7 network has its own point code assigned thereto. In accordance with an embodiment, the IVR populates the MTP header field with the point code of the SCP. The IVR then populates another part of the message, the SCCP called party address, with the point code and subsystem of the SCP. The IVR then sends the message over the SS7 network to reach its destination.

In another embodiment, the IVR populates the SCCP called party address with the E.164 address assigned to the SCP. The IVR also sets bits to indicate route-on-global-title. The message is then sent for outbound IVR processing. At this point, the message may be translated into the Point code needed for the SCP or it can result in the point code of the STP. If it is translated as the point code of the STP, then the STP performs the steps per existing protocols to route the call to the SCP.

In another embodiment, the E.164 address of the SCP is obtained from the LAM message sent from the SSP. As discussed earlier, the SCP sends its addressing information to the SSP where the SSP in turn sets up a call to the IVR and passes the information in the LAM message. Part of this information comprises the E.164 address assigned to the SCP. The IVR inserts this information into the SCCP called party address of the first message it addresses for the SCP for the call. At this point, the IVR may perform a global title translation (GTT) on an outbound basis before leaving the IVR resulting in the point code and subsystem number of the desired SCP, e.g., one of SCPs 280 and 281. The other option is for the IVR to address the message to the STP and let the STP perform the GTT.

In another embodiment, a method is provided for communicating using multiple languages by creating separate internal directories within the IVR that each supports its own language. Prerecorded phrase or other audio files (e.g., .wav or other audio files) are loaded into the appropriate directory. A table structure is also defined where the user assigns a language identifier to one or more AnnIds. The language identifier is used to direct processing to the appropriate language directory such that the desired recording in the desired language may be played. Additionally, files used to interpret the variable parts must also reside in the appropriate language directories.

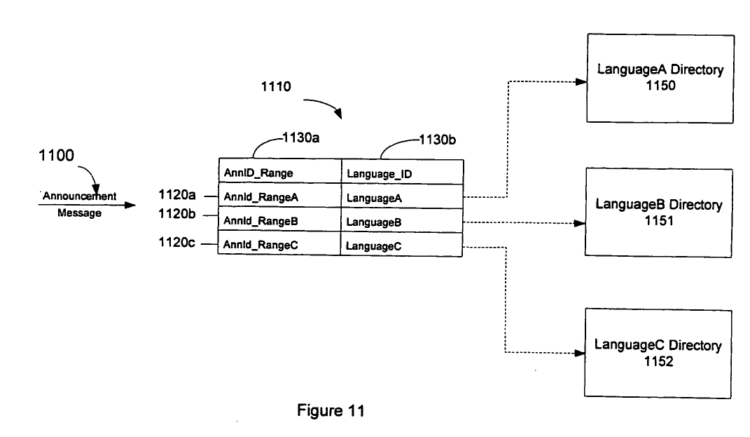

With reference to FIG. 11, a diagrammatic representation of an embodiment of an IVR configuration for communicating using multiple languages is shown. IVR 610 maintains, interfaces, or is otherwise communicatively coupled with, a language mapping table 1110 that facilitates playback of announcements of different languages. Multiple language directories 1150-1152 may be loaded with announcements, such as audio files (either fixed or variable), in respective languages. For example, directory 1150 may be loaded with English language announcement phrase files, directory 1151 may be loaded with Spanish language announcement phrase files, and directory 1152 may be loaded with French language announcement phrase files. Each of directories 1150-1152 may comprise one or more tables, files or other data structures. For example, directories 1150-1152 may be formatted in manner similar to tables 300 or 400 shown in FIGS. 3 and 4, respectively.

Table 1110 provides logic for mapping a received announcement message 1100 to one of language directories 1150-1152. Announcement message 1100 may be formatted similar to announcement message 500 described with reference to FIG. 5. For example, announcement message 1100 may include an AnnID and optionally may include one or more variable part data and associated variable part data indicators. In the illustrative example, table 1110 includes records 1120a-1120c that respectively provide a mapping to one of directories 1150-1152. For example, a field 1130a of table 1110 defines AnnID ranges in records 1120a-1120c and respective associated language directory identifiers in field 1130b. For example, AnnID ranges defined in field 1130a may include a lowermost and uppermost AnnID value of an AnnID range that is associated with a particular language directory. In other implementations, the AnnId ranges defined by field 1130a may comprise non-contiguous AnnID values.

On receipt of announcement message 1100 from a SCP, IVR 210 reads an announcement ID from the announcement message and queries table 1110 therewith. If a range is identified as including the AnnID read from announcement message 1100, processing is directed to the appropriate language directory. The announcement ID may then be used to obtain one or more phrase files from the language directory.

A default language may be specified in the IVR configuration files. Any variable parts associated with an unassigned language announcement ID may be played using the default language. For example, the default language may be set to English or another appropriate language, e.g., based upon a customer request.

When processing announcements, the language indication is implicit in the announcement ID due to the designation of announcement ID ranges to specific languages.

Other languages may be provided to extend the capabilities of the system. For each new language added, a prompt-rules file and an associated language file (i.e., .vox file) may be setup and installed.

For assignment of variable announcements to languages, the IVR provides a range table where a system operator or other authorized personnel may assign a range of announcement IDs to a specific language.

In another embodiment, a method for virtually instantaneously updating phrase files is provided. As indicated earlier, phrase files are stored in language directories. Each time the IVR processes an AnnId, the IVR retrieves and then plays phrase files assigned to the AnnId. These phrase files are obtained from a language directory. This implementation results in an immediate announcement change upon phrase file replacement. The new phrase file may thus be substantially immediately activated upon replacement or loading of a new phrase file in a phrase file directory.

In another implementation, an administrative operation on announcements may become effective within a predefined time, e.g., 30 minutes. Accordingly, a delay of no longer than the predefined time elapses from the time the announcement provisioning is completed and delivered to the IVR to the time the update is available for new calls.

The IVR may notify an operator via an event message or signal when an updated announcement range table or announcement ID table becomes active on the system regardless of whether the update was activated automatically or manually.

The IVR may support various message processing procedures, including, but not limited to, Repeat Message functionality, Duration functionality, Interval functionality, Duration and Number of Repetitions functionality, Interval, Duration and Number of Repetitions functionality, and DTMF digit functionality.

Repeat Message functionality comprises an IVR procedure to repeat a message multiple times. The number of repetitions will be determined by the SCP application. For example, the SCP may pass a value indicating the number of times that the SCP wishes the IVR to repeat the message.

Duration functionality comprises the ability of the IVR to play an announcement for a duration specified by the application. This allows for an announcement to be played continuously until the requested duration expires.

Interval functionality comprises the ability of the IVR to replay a message after expiration of an interval X. For example, if a message is received from the SCP that indicates an Interval X and a Repeat designation, the announcement may be replayed after pausing X seconds. The length X in seconds of the interval is specified by data received from the SCP.

Duration And Number of Repetitions functionality provides for termination of playback of an announcement having both a duration and a number of repetitions specification by the application when either of two events occurs without waiting for the other event to take place. In other words, if the duration expires prior to playback of the message the number of times specified by the repetitions value, playback of the message is terminated. Likewise, if the message is played back the number of times specified by the repetitions value prior to expiration of the duration, playback of the message is terminated.

Interval, Duration and Number of Repetitions functionality provides for termination of playback of a message having an interval X, a duration and a Number of repetitions specified by the application. The announcement is replayed after pausing X seconds provided the Duration has not been exceeded. The announcement is terminated if the announcement is still performing the Interval and Repetitions and the Duration expires. The IVR provides DTMF functionality for receipt of DTMF digits from subscribers who are connected to the IVR. DTMF digits are received by the system when instructed by the application.

Each CM is equipped with one SS7 interface card that supports up to a predefined number, e.g., 16, of SS7 links. Additional SS7 interface cards can be added based on CM slot availability.

The IVR may use ANSI SS7-MTP for MTP protocol and ANSI SS7-SCCP for SCCP protocol.

The IVR may support necessary application contexts in a CAMEL protocol, e.g., the CAMEL v2 protocol, to communicate with the application.

Bearer channels may be implemented on T1's that are configurable in terms of line code and framing. A default configuration, such as uses B8ZS and ESF, may be defined for the bearer channels.

The IVR may utilize the first eleven digits of IAM messages' CPN as the SCCP Called Party global title digits for setting up the GTT and application dialogue with the SCP.

Translation Type 10 according the ANSI SS7-SCCP may be used for all GTT messaging to and from the SCP.

The IVR may provide processing capacities to query and display the status of each circuit and may support the circuit management procedures per T1.113.

Additionally, the IVR may automatically send CGB messages if the IVR main application becomes unavailable.

If a CM goes completely down, or becomes otherwise unavailable, all ISUP messages will be sent to the other operational CM. There will be no access in this mode to the bearer paths of the failed CM. The IVR may be configured to react with CGB for each IAM received destined for the failed CM. In this mode, any unrecognized L&M will be responded to using CGB. If one CM becomes out of service, the other CM shall respond with CGB to all IAM messages that have DPC/CIC codes not resident on the active CM.

To synchronize circuit states when bringing a CM or the entire IVR back into operation after a restart, one of the following actions may be performed: (1) Send CQM, GRS or RSC from the MSC to the IVR for the CIC or group to be enabled; or (2) Send a UBL or CGU to the MSC via the Local MML command unblock from the IVR side.

The various functions, processes, methods, and operations performed or executed by the system can be implemented as programs that are executable on various types of processors, controllers, central processing units, microprocessors, digital signal processors, state machines, programmable logic arrays, and the like. The programs may be stored on a computer-readable medium for use by or in connection with a computer system or method. A computer-readable medium may be implemented as, for example, an electronic, magnetic, optical, or other physical device or means that can store a computer program for use by or in connection with a computer system, method, process, or procedure. Programs may be embodied in a computer-readable medium for use by or in connection with an instruction execution system, device, component, element, or apparatus, such as a system based on a computer or processor, or other system that can fetch instructions from an instruction memory or storage of any one or more suitable types. A computer-readable medium may be implemented as any structure, device, component, product, or other means that can store, communicate, propagate, or transport the program for use by or in connection with the instruction execution system, apparatus, or device.

The flowchart provided herein depicts process serialization to facilitate an understanding of the invention and is not necessarily indicative of the serialization of the operations being performed. The illustrative block diagrams and flow charts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, and the like.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of providing interactivity in a communication system, comprising:
receiving, from a service control point, a message including an announcement identifier;
determining, based on contents of the message, that an announcement including at least one variable part is to be played;
translating contents of the message into a value for retrieving at least one variable part audio file from a data storage; and
obtaining the at least one variable part audio file.

2. The method of claim 1, wherein receiving the message further comprises receiving a CAMEL formatted message including the announcement identifier.

3. The method of claim 1, wherein translating further comprises translating the contents to a value for retrieving the at least one variable part audio file from a VOX file that comprises a plurality of variable part audio files.

4. The method of claim 1, further comprising retrieving at least one fixed phrase audio file.

5. The method of claim 1, further comprising:
reading respective contents of a variable part data field and a variable part data indicator field from the message; and
deriving a value from the contents of the variable part data field and the variable part data indicator that is used to obtain the at least one variable part audio file.

6. The method of claim 1, further comprising querying a table that comprises logic for mapping the announcement identifier to a directory of a plurality of directories, wherein the directory includes audio files of one language.

7. The method of claim 6, further comprising comparing the announcement identifier with one or more announcement identifier ranges in the table.

8. An interactive voice response system for providing interactivity in a communication system, comprising:
a first control manager including an interface to a signaling network, first resources for provisioning of bearer channels, and a first plurality of expansion slots; and
a second control manager including an interface to the signaling network, second resources for provisioning of bearer channels, and a second plurality of expansion slots, wherein the first control manager and the second control manager are commonly associated with a point code.

9. The system of claim 8, wherein messages directed to the first control manager are conveyed to the second control manager in the event the first control manager is non-operational, and wherein messages directed to the second control manager are conveyed to the first control manager in the event the second control manger is non-operational.

10. The system of claim 8, wherein the first resource is implemented as a respective digital carrier expansion card interfaced in one of the first plurality of expansion slots, and wherein the second resource is implemented as a respective digital carrier expansion card interfaced in one of the second plurality of expansion slots.

11. The system of claim 8, wherein the first control manager further includes a first expansion module interfaced in one of the first plurality of expansion slots, and wherein the second control manger further includes a second expansion module interfaced in one of the second plurality of expansion slots.

12. The system of claim 11, wherein the first resource is implemented as at least one respective digital carrier expansion card interfaced with the first expansion module, and wherein the second resource is implemented as at least one respective digital carrier expansion card interfaced with the second expansion module.

13. A computer-readable medium having computer-executable instructions for execution by a processing system, the computer-executable instructions for providing interactivity in a communication system, comprising:
instructions that receive a message including an announcement identifier;
instructions that determine, based on contents of the message, that an announcement including at least one variable part is to be played;
instructions that translate contents of the message into a value for retrieving at least one variable part audio file from a data storage; and
instructions that obtain the at least one variable part audio file.

14. The computer-readable medium of claim 13, wherein the instructions that receive the message further comprise instructions that receiving a CAMEL formatted message including the announcement identifier.

15. The computer-readable medium of claim 13, wherein the instructions that translate further comprise instructions that translate the contents to a value for retrieving the at least one variable part audio file from a VOX file that comprises a plurality of variable part audio files.

16. The computer-readable medium of claim 13, further comprising instructions that retrieve at least one fixed phrase audio file.

17. The computer-readable medium of claim 13, further comprising:
instructions that read respective contents of a variable part data field and a variable part data indicator field from the message; and
instructions that derive a value from the contents of the variable part data field and the variable part data indicator that is used to obtain the at least one variable part audio file.

18. The computer-readable medium of claim 13, further comprising instructions that querying a table that comprises logic for mapping the announcement identifier with a directory of a plurality of directories, wherein the directory includes audio files of one language.

19. The computer-readable medium of claim 18, further comprising instructions that compare the announcement identifier with one or more announcement identifier ranges in the table.
